(19) United States
(12) Patent Application Publication
(10) Pub. No.: US 2012/0146800 A1
(43) Pub. Date: Jun. 14, 2012

(54) COMPUTER SYSTEM CAPABLE OF DETECTING CONNECTION OF NETWORK CABLE TO NETWORK CABLE INTERFACE

(75) Inventors: CHUNG-CHI HUANG, Tu-Cheng (TW); XUN-CHUN QIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/978,624

(22) Filed: Dec. 26, 2010

(30) Foreign Application Priority Data
Dec. 8, 2010 (CN) 201010578856.9

(51) Int. Cl. G08B 21/18

(52) U.S. Cl. 340/652

(57) ABSTRACT

A computer system includes a cabinet, a motherboard, and a control device. The cabinet includes a front panel. The front panel has an network cable interface. The motherboard is received in the cabinet and electrically connected to the network cable interface. The control device includes a controller and an LED. The LED is positioned on the front panel. The controller is connected to the LED and the network cable interface. The controller turns the LED on if detecting that a network cable is plugged into the network cable interface and turns the LED off if detecting that the network cable is plugged out from the network cable interface.

### BACKGROUND

1. Technical Field

The disclosure relates to computers and, particularly, to a computer system capable of detecting connection of a network cable to a network cable interface.

2. Description of Related Art

Computers usually include a front panel that usually faces to users and a rear panel that usually faces away users. Interfaces, such as network cable interface, VGA (Video Graphics Array) interface, and USB interface, of the computer are usually arranged at the back panel. However, when testing or fixing the computer, it is usually required to frequently plug in and plug off cables. Thus, users have to turn the computer back and forth frequently, which is inconvenient.

Therefore, it is desirable to provide a computer system which can overcome the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure.

FIG. 1 is a schematic view of a cabinet of a computer system, in accordance with an embodiment.

FIG. 2 is a functional diagram of the computer system of FIG. 1.

### DETAILED DESCRIPTION

Embodiments of the present disclosure will now be described in detail with reference to the drawings.

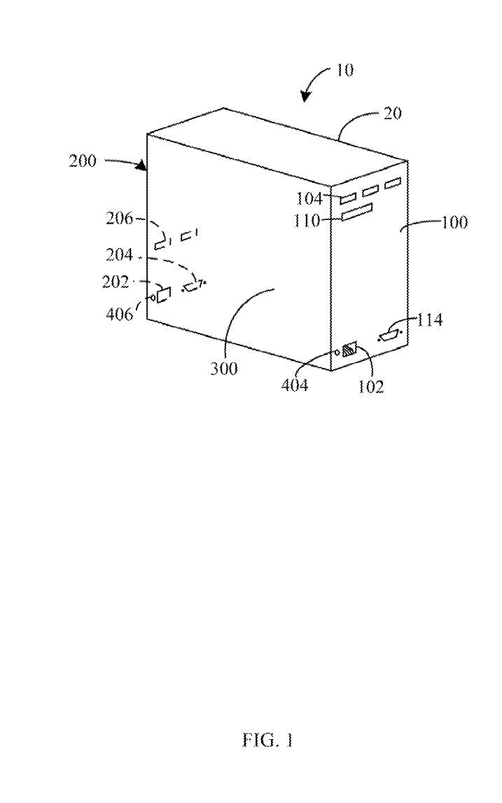

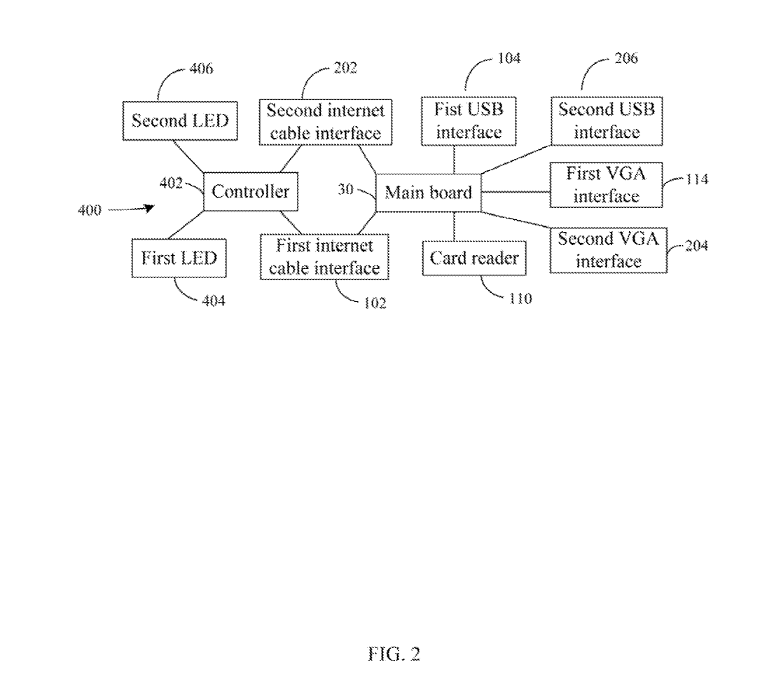

Referring to FIGS. 1 and 2, a computer system 10, according to an embodiment, includes a cabinet 20 and a motherboard 30 received in the cabinet 30. The cabinet 20 includes a front panel 100, a rear panel 200, and a body 300 connecting the front panel 100 and the rear panel 200. The cabinet 20 is usually oriented in a manner that the front panel 100 faces users while the rear panel 200 faces away the users.

The front panel 100 includes at least one first network cable interface 102 that is connected to the motherboard 30. In the illustrated embodiment, the front panel 100 includes a number of first USB interfaces 104 and a card reader 110 at the top thereof, one first network cable interface 102 and a first VGA cable interface 114 at the bottom thereof. The first USB interfaces 104, the card reader interface 110, the first network cable interface 102, and the first VGA interface 114 are all connected to the motherboard 30 of the computer system 10.

The rear panel 200 includes at least one second network cable interface 202 that is connected to the motherboard 30. In the illustrated embodiment, the rear panel 200 includes one second internet interface 202, a second VGA interface 204, and a number of second USB interfaces 206. The second internet interface 202, the second VGA interface 204, and the second USB interfaces 206 are also connected to the motherboard 30 of the computer system 10.

When users have to plug in and plug off cables, they don't have to turn the cabinet 20 back and forth, which is convenient, especially when the cabinet 10 is put in a limited space.

In alternative embodiments, the computer system 10 further includes a control device 400. The control device 400 includes a controller 402, a first LED 404 arranged on the front panel 100 and beside the first network cable interface 102, and a second LED 406 arranged on the rear panel 200 and beside the second network cable interface 202. The controller 402 is connected to the first LED 404, the second LED 406, the first network cable interface 102 and the second network cable interface 202. The controller 402 is configured for detecting whether a network cable (not shown) is plugged into one of the first network cable interface 102 and the second network cable interface 202, if yes, the controller 402 turns on a corresponding one of the first LED 404 and the second LED 406 to prompt the users that a network cable has been connected to the computer system 10; if not, the controller 402 turns off the first LED 404 and the second LED 406 to prompt the users that the computer system has not been connected to the Internet yet.

It will be understood that the above particular embodiments is shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A computer system, comprising:
a cabinet comprising a front panel, the front panel having a first network cable interface;
a motherboard received in the cabinet and electrically connected to the first network cable interface; and
a control device comprising a controller and a first LED, the first LED positioned on the front panel, the controller connected to the first LED and the first network cable interface, the controller configured to turn the first LED on if detecting that a network cable is plugged into the first network cable interface and configured to turn the first LED off if detecting that the network cable is plugged out from the first network cable interface.

2. The computer system of claim 1, wherein the front panel comprises a plurality of first USB interfaces and a card reader at the top thereof, the first USB interfaces, and the card reader are electrically connected to the motherboard.

3. The computer system of claim 1, wherein the front panel comprises a first VGA cable interface electrically connected to the motherboard, the first VGA cable interface and the first network cable interface are positioned at the bottom the front panel.

4. The computer system of claim 1, wherein the cabinet further comprises a rear panel and a body connecting between the front panel and the rear panel.

5. The computer system of claim 4, wherein the rear panel comprises a second network cable interface that is electrically connected to the motherboard.

6. The computer system of claim 5, wherein the rear panel further comprises a second VGA interface and a plurality of second USB interfaces, the second VGA interface and the second USB interfaces are electrically connected to the motherboard.

7. The computer system of claim 5, wherein the control device comprises a second LED arranged on the rear panel, the controller is connected to the second LED and the second network cable interface, the controller is configured to turn the second LED on if detecting that a network cable is plugged into the second network cable interface and configured to turn the second LED off if detecting the network cable is plugged out from the second internet interface.
